(19) United States
(12) Patent Application Publication
(10) Pub. No.: US 2003/0088967 A1
(43) Pub. Date: May 15, 2003

(54) Endless core for a multiphase transformer and a transformer incorporating same

(76) Inventors: Barry Reginald Hobson, North Lake (AU); Christopher Paull Revill, Warwick (AU); Angelo Paoliello, Sawyer Valley (AU); Eric Roberts Laithwaite, Surrey (GB); David Bagnall, West Sussex (GB)

Correspondence Address: MCGARRY BAIR PC, 171 MONROE AVENUE, N.W., SUITE 600, GRAND RAPIDS, MI, 49503, US

(21) Appl. No.: 10/063,281

(22) Filed: Apr. 8, 2002

Related U.S. Application Data
(63) Continuation-in-part of application No. 09/421,897, filed on Oct. 21, 1999, now abandoned.

(30) Foreign Application Priority Data
Nov. 13, 1998 (AU) PP7124
May 13, 1999 (AU) PQ0358

(51) Int. Cl. H01F 7/06

(52) U.S. Cl. 29/592.1; 29/602.1; 29/605; 29/606

(57) ABSTRACT

A core for a multi-phase transformer includes a body made of two or more rings having a common central axis. Each ring consists of a strip of magnetic permeable material wound about the central axis. The body is provided with a plurality of radially disposed windows, each window being bound by opposed axially extending legs and opposed circumferentially extending branches. The branches of each window are provided in respective axially adjacent rings, so that the branches and legs of each window define a closed magnetic circuit of substantially uniform magnetic permeability through which magnetic flux can circulate about the windows.

### CROSS REFERENCE TO RELATED APPLICATIONS

This application is a continuation in part of U.S. application Ser. No. 09/421,897 filed Oct. 21, 1999, which claims the benefit of Australian Application Serial No. PQ0358 filed May 13, 1999 and Australian Application Serial No. PP7124 filed Nov. 13, 1998.

### BACKGROUND OF INVENTION

1. Field of the Invention

The present invention relates to an endless core for a multiphase transformer and a transformer incorporating such a core.

2. Description of the Related Art

Multiphase transformers are well known and are used in a variety of applications including for stepping up or stepping down line voltage in power transmission systems, to provide phase shifting, modulation, star-delta converters and general power supplies.

A typical multiphase transformer has a planar core provided with a number of square or rectangular windows each window being bound by upper and lower branches of the core, and on opposite sides by vertical legs forming part of the core. A primary winding is wound through each window, either on a branch or leg of the window. Similarly a secondary winding is wound through each window. Irrespective of the number of phases, if the core has N windows then it will have N+1 vertical legs. This provides an inherent magnetic and therefore electrical imbalance between the phases. This arises because the magnetic flux created by current flow in the primary windings cannot circulate equally about the respective windows because of the additional vertical leg. As a result, assuming each primary phase voltage is of the same magnitude and each secondary winding has the same number of turns, then the secondary outputs cannot be the same. The transformation process is not identical between the phases due to the difference in magnetic paths surrounding each window. In order to produce equalized outputs on the secondary windings, i.e. the same magnitude output on each winding, some of the primary or secondary windings must vary the number of turns to take account of the difference in flux distribution circulating about different windows of the transformer core. Such transformers also have inherent inefficiencies due to flux leakage caused by the exposed, dead end nature of the core and the end windows having only a single oscillating flux path.

### SUMMARY OF THE INVENTION

It is an object of the present invention to provide a transformer core and an associated transformer that attempts to alleviate at least the abovementioned problems in the prior art.

According to a first aspect of the invention there is provided a core for a multi-phase transformer, said core including a body made of two or more rings having a common central axis, each ring consisting of a strip of magnetic permeable material wound about said central axis, said body provided with a plurality of windows passing radially through said body, each window bound by opposed axially extending legs and opposed circumferentially extending branches, wherein said branches of each window are provided in respective axially adjacent rings, said branches and legs of each window defining a closed magnetic circuit of substantially uniform magnetic permeability through which magnetic flux can circulate about said windows.

Preferably the core includes a plurality of primary windings, one primary winding provided for each electrical phase, each primary winding having at least one turn wound directly about a branch or a leg of a corresponding window.

Preferably at least one of said primary windings is wholly wound about one or both branches of said corresponding window.

Preferably at least one of said primary windings is wholly wound about one or both legs of said corresponding window.

Preferably at least one of said primary windings has a plurality of turns wherein at least one of said turns is wound about one branch of said corresponding window and at least one turn is wound about one leg of said corresponding window.

According to a further aspect of the invention there is provided a multi-phase transformer including at least:

a core according to the first aspect of this invention;

a plurality of primary windings, one primary winding being provided for each electrical phase of said transformer; and,

a plurality of secondary windings;

each primary winding having at least one turn wound directly about a branch or a leg of a corresponding window to produce lines of magnetic flux which circulate about said corresponding window; and,

at least one of said secondary windings having at least one turn wound directly about a branch or a leg of a window about which said lines of magnetic flux circulate to induce the current in said at least one secondary winding.

Preferably at least one primary winding is wound directly about at one or both branches of one window, and at least one secondary winding is wound directly about one or both branches of said one window.

Preferably at least one primary winding is wound directly about one or both branches of one window, and at least one secondary winding is wound directly about one or both legs of said one window.

Preferably at least one primary winding is wound directly about one or both branches of one window, and at least one secondary winding is wound directly about at least one branch and at least one leg of said one window.

Preferably at least one primary winding is wound directly about one or both branches of one window, and at least one secondary winding is wound directly about a branch or a leg of said one window, and directly about a branch or a leg of another window.

Preferably at least one primary winding is wound directly about one or both legs of one window, and at least one secondary winding is wound directly about one or both branches of said one window.

Preferably at least one primary winding is wound directly about one or both legs of one window, and at least one secondary winding is wound directly about one or both legs of said one window.

Preferably at least one primary winding is wound directly about one or both legs of one window, and at least one secondary winding is wound directly about at least one branch and at least one leg of said one window.

Preferably at least one primary winding is wound directly about one or both legs of a window, and at least one secondary winding is wound directly about at least one branch or one leg of said one window, and about at least one branch or one leg of another window.

Preferably at least one primary winding is wound directly about at least one branch and at least one leg of one window, and at least one secondary winding is wound directly about a branch or a leg of said one window.

Preferably at least one primary winding is wound directly about at least one branch and at least one leg of one window, and at least one secondary winding is wound directly about at least one branch and at least one leg of said one window.

According to another aspect of the invention there is provided a core for a multi-phase transformer, said core including a body made of magnetically permeable material in the shape and configuration of a loop about a central axis, said body provided with a plurality of windows passing axially through said body, each window defined by radially opposite branches and circumferentially opposite legs, where each leg is common to two circumferentially adjacent windows.

Preferably the core includes a plurality of primary windings, one primary winding provided for each electrical phase, each primary winding having at least one turn wound directly about a branch or a leg of a corresponding window.

Preferably the radially opposite branches of each window are configured to have the same volume of magnetically permeable material.

The invention also provides a method of constructing a core according to the first aspect of this invention, said method including the steps of stamping and winding about said central axis a strip of magnetically permeable material to form said body, said stamping arranged to produce said plurality of windows passing radially through said body.

Preferably the method includes the step of splitting said core through a plane passing through said windows.

The invention also provides a method of constructing a core according to the first aspect of this invention, said method including the steps of stamping strips of magnetically permeable material to form respective rings, aligning said rings along said common central axis, said stamping and aligning arranged to produce said plurality of windows.

The invention also provides a method of constructing a core according to the first aspect of this invention, said method including the steps of continuous winding about said central axis a strip of magnetically permeable material to form said body; and machining, cutting or otherwise forming said plurality of windows radially through said body.

Preferably the method includes the step of splitting said core through a plane passing through said windows.

Preferably the method includes the step of loading a prewound bobbin on one or more legs of said core.

The invention also provides a method of constructing a core according to the first aspect of this invention, said method including the steps of continuous winding strips of magnetically permeable material to form respective rings, and machining or forming said plurality of windows radially through respective rings of said body, aligning said rings along said common central axis to form said body, said machining and aligning arranged to produce said plurality of windows.

The invention also provides a method of constructing a core according to the first aspect of this invention, said method including the steps of continuous winding strips of magnetically permeable material to form respective rings, aligning said rings along said common central axis to form said body, said rings being spaced apart by an array of legs to form a plurality of windows passing radially through said body, wherein said branches of each window are provided in respective axially adjacent rings.

### BRIEF DESCRIPTION OF THE DRAWINGS

Embodiments of the present invention will now be described by way of example only with reference to the accompanying drawings in which:

FIG. 1 is a perspective view of a core in accordance with the present invention and a six phase transformer incorporating that core.

FIG. 2 is a perspective view of a second embodiment of the core and a 12 phase transformer incorporating that core.

FIG. 3 is a perspective view of a third embodiment of the core in accordance with the present invention.

FIG. 4 is a perspective view of a fourth embodiment of the core.

FIG. 5 is a cutaway perspective view of an electric motor incorporating a core in accordance with the present invention.

FIG. 6 illustrates one method of manufacture of a core in accordance with the present invention.

FIG. 7 illustrates another method of manufacture of the core.

FIG. 8 illustrates another method of manufacture of the core.

FIG. 9 illustrates another method of manufacture of the core.

FIG. 10 illustrates another method of manufacture of the core.

### DETAILED DESCRIPTION

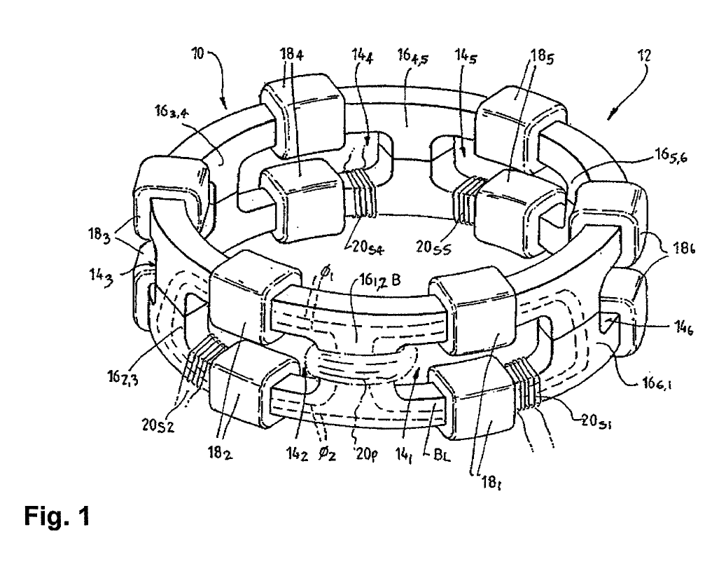

Referring to FIG. 1, there is illustrated a core 10 for a multiphase (in this example, six phase) transformer 12. The core 10 is in the general form of an annulus. A plurality of windows 14₁-14₆ (referred to in general as windows 14ᵢ ) are formed through and about the core 10. Adjacent windows 14ᵢ share a common portion or leg 16_{i,j} where ᵢ and ⱼ designate the adjacent windows. For example, leg 16_{1,2} is the portion of core 10 between adjacent windows 14₁ and 14₂; and leg 16_{4,5} is the portion or leg of core 10 between adjacent windows 14₄ and 14₅. Due to the configuration of the core 10, there are no dead ends in so far as magnetic flux is concerned and therefore the core 10 facilitates the existence of symmetrical magnetic flux through the core 10.

Each window 14ᵢ is bound on opposite sides by the adjacent, core portions or legs 16_{i,j} and, by upper and lower branches Bᵤ and Bₗ. Thus, for example window 14₁ is bound on the left side by common core portion 16_{1,2}; on the right side by common core portion 16_{6,1}; upper branch Bᵤ; and, lower branch Bₗ.

Multiphase transformer 12 is constructed by winding respective primary and secondary windings through the windows 14ᵢ. In the embodiment shown, primary windings 18₁ and 18₆ (referred to in general as primary windings 18ᵢ) link with respective windows 14ᵢ. More particularly, two primary windings 18ᵢ (of the same phase) are provided for each window 14ᵢ, with one primary winding about the upper branch Bᵤ and another primary winding about a lower branch Bₗ of each window 14 ᵢ.For example, looking at window 14₁ a pair of primary windings 18₁ is provided, one of each formed about the upper branch Bᵤ and lower branch Bₗ of the window 14 ₁.

When the primary windings 18ᵢ are coupled to respective phases of a six-phase AC power supply lines of magnetic flux φᵢ are generated and circulate about at least the window through which the primary winding 18ᵢ is wound. Again taking for example window 14₁ when the primary windings 18₁ are connected to one phase of the six-phase AC power supply, lines of magnetic flux φ₁ are generated that circulate about window 14₁. However, it must be appreciated that the magnetic flux generated can also circulate or return about other windows 14ᵢ. Thus a part of the magnetic flux φ₁ can circulate about both windows 14₁ and 14₂ returning through legs 16_{2,3} and 16_{6,1} and circulate about windows 14₁, 14₂ and 14₆ returning via legs 16_{2,3} and 16_{5,6}.

The placement of secondary windings through the windows 14ᵢ is dependent upon the desired output. If it is desired that the phase of the output from the secondary windings is to be the same as the phase of the corresponding primary winding then secondary windings 20ₛ₁-20ₛ₆ can be wound for example about the lower branch Bₗ of each window 14₁-14₆ respectively. (Of course in a variation, the secondary windings 20ₛ₁-20ₛ₆ can be placed about the upper branches Bᵤ of each window or even alternate between the upper and lower branches.) It will be appreciated that because of the symmetric distribution of magnetic flux φᵢ about each of the windows 14ᵢ, assuming that the primary voltage for each phase is of the same magnitude, the magnitude of the voltage output from the secondary windings 20ₛᵢ will be the same if each of the secondary windings 20ₛᵢ have the same number of turns. Thus, the core 10 and transformer 12 provide the ability to have secondary output of equal magnitude where the secondary windings 20ₛ₁-20ₛ₆ have the same number of turns. As discussed above in relation to the prior art, because of the inherent magnetic imbalance of known cores and transformers, in order to have secondary outputs of equal magnitude in a multiphase transformer one must deliberately design some of the coils to have different number of turns.

The core 10 and transformer 12 also allow for an infinite possibility of phase shifting or combining. If one wanted to obtain a secondary output of a phase halfway between the phases of say the primary voltages supplying primary windings 18₁ and 18₂ then a secondary winding 20ₚ (shown in phantom) can be wound through both windows 14₁ and 14₂ i.e. about the common core portion 16_{1,2}. Now, the second winding 20ₚ links with the magnetic flux φ₁ and φ₂ and thus the secondary output is of a magnitude and phase corresponding to the vector or phasor addition of the voltage induced by fluxes φ₁ and φ₂. This provides a 1:1 transformed combination of the phases feeding primary windings 18₁ and 18₂. However combinations of other ratios and thus different amounts of phase shifting can be achieved at will by simply winding the secondary winding 20ₚ about the upper or lower branches Bᵤ, B ₗ or common core portions 16_{i,j} of different windows. For example, in the embodiment shown in FIG. 1, the primary phases are 60° apart. To obtain a secondary output having a phase 15° (i.e. ¼ the phase difference) in advance of the phase of the primary voltage feeding primary winding 18₁ a secondary winding (not shown) is provided having a 1:4 turn ratio about branch Bₗ of window 14₁ and branch Bₗ of window 14₂, i.e. the secondary winding has four turns passing through window 14₂ for every turn passing through window 14₁.

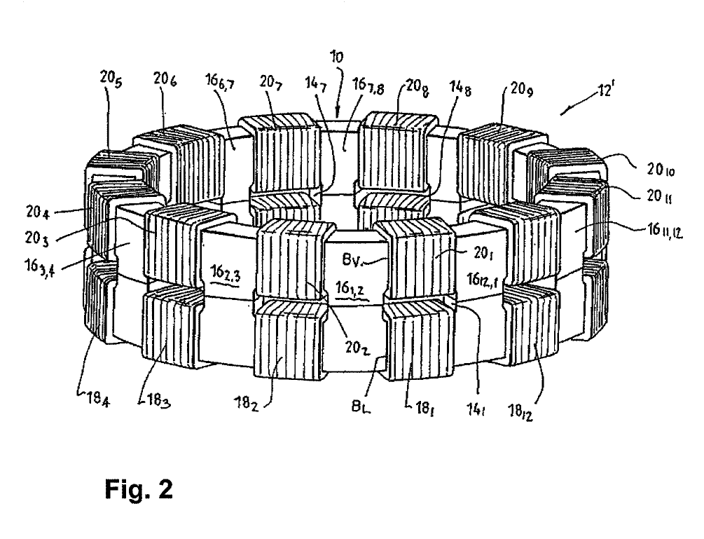

FIG. 2 illustrates a core 10′ suitable for constructing a twelve phase transformer 12′. Here, the core 10′ is again in shape of a ring or annulus but this time provided with twelve windows 14₁-14_{1,2} and twelve common core portions 16_{i,j}, one of each between respective adjacent windows 14ᵢ. A primary winding 18ᵢ is wound about lower branch Bₗ of each window 14ᵢ. A secondary winding 20ᵢ is wound about the upper branch Bᵤ of each window 14ᵢ. The phase of the output of any secondary winding 20ᵢ is the same as the phase of voltage driving the corresponding primary winding 18ᵢ. However, as with the previous embodiment, the secondary winding 20ᵢ can be wound partially about the upper and lower branches Bᵤ and Bₗ or common core portions 16_{i,j} of different windows in any desired combination to produce a desired phase output in accordance with standard transformer design techniques.

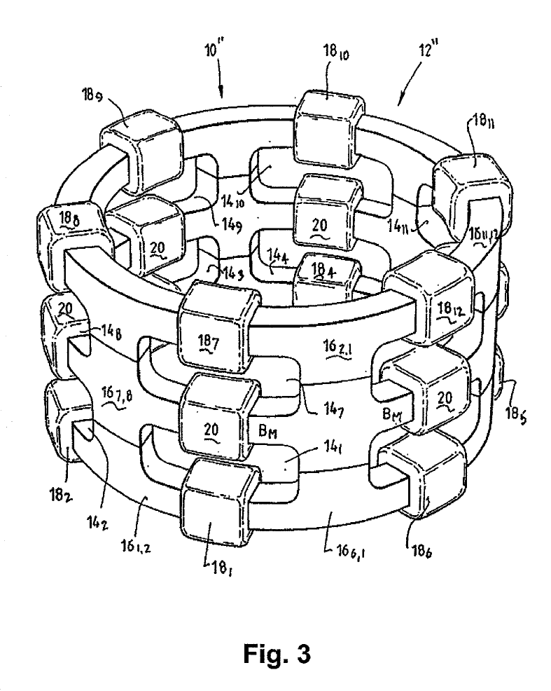

FIG. 3 illustrates an extending (vertically stacked) core 10″ and a multiphase transformer 12″ constructed using the core 10″. The core 10″ can be considered as being two six window cores vertically stacked upon each other. Thus the core 10″ has a lower set of windows 14₁-14₆ and an upper set of windows 14₇-14₁₂ with windows 14ᵢ and 14ᵢ₊₆ in vertical alignment. Primary windings 18₁-18₆ are wound about the lower branches Bₗ of windows 14₁-14₆ respectively; and, primary windings 18₇-18_{1,2} are wound about the upper branches Bₗ of the upper set of windows 14₇-14_{1,2}. A set of secondary windings 20 are wound about the middle branch Bₘ between vertically adjacent windows 14ᵢ, 14ᵢ₊₆. Therefore, in this particular illustrated embodiment, there are only six secondary coils 20. The output of any particular secondary winding 20 would be the transformed phasor or vector addition of voltages induced by the magnetic flux generated by the primary windings linked with the windows common to that particular secondary winding 20. In order to avoid saturation it is preferred that the volume of core constituting the middle branch Bₘ is the sum of the volume of the core constituting the lower branch Bₗ and upper branch Bᵤ of the windows 14ᵢ, 14ᵢ₊₆. This embodiment then allows the combination of two six phase supplies that are out of phase with each other. For example, if there are two six phase power supplies, one providing input to coils 18₁-18₆ and another providing input to primary windings 18₇-18_{1,2}, the two power sources can be combined to provide a six phase output through the secondary windings 20. This could be particularly useful in for example coupling two multiple phase power supplies to a common power transmission grid. The core configuration will also allow for the ability to have 6 primary and 12 secondary windings. Also a turns ratio of 1/0.5 primary to secondary, or secondary to primary, as well as incorporating other windows will produce any fraction of volts required.

In a different configuration (not illustrated) the primary windings 18₁-18_{1,2} of transformer 12″ can be connected to a different phase of a twelve phase power supply and primary windings 20 round through various windows 14ᵢ to provide a transformed twelve phase output. Again, the phasing of the output from the secondary windings can be arranged as required in accordance with known transformer design techniques to provide the desired secondary phase output.

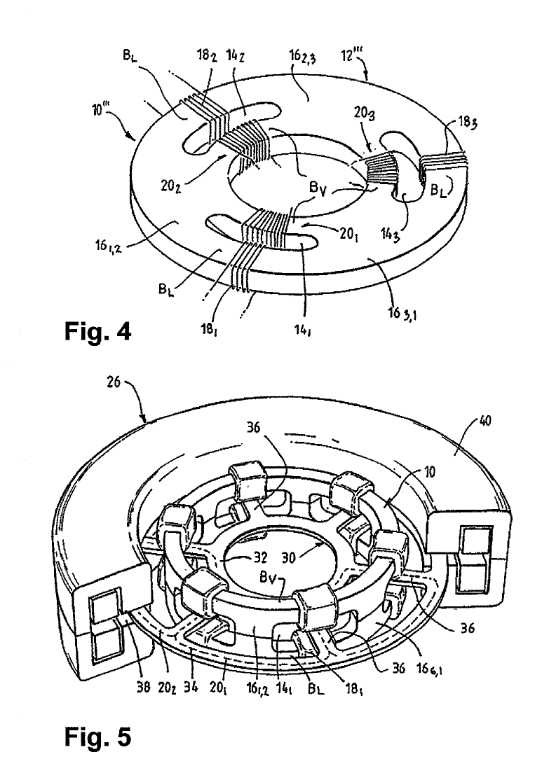

FIG. 4 further illustrates a further embodiment of the core 10′″ and a corresponding 12′″. In the embodiments shown in FIGS. 1-3 the core 10 and windows 14ᵢ extend perpendicular to the axis of the core 10. That is the windows 14 ᵢ are formed through the radial direction of the core. With the core 10′″ of FIG. 4, the axis of the core 10 is parallel with the axis of any window 14ᵢ. As with all previous embodiments, core 10′″ is configured in the general form of an annulus or ring having a plurality of windows 14ᵢ where adjacent windows share a common portion of core 16_{i,j} so that they number of windows 14ᵢ equals the number of common core portions 16_{i,j}. More specifically, three windows 14₁-14₃ are formed in the core 10′″ with a primary winding 18₁-18₃ respectively wound about the lower (radially outer most) branches Bₗ of each window 14ᵢ. Respective secondary windings 20₁-20₃ are wound through the windows 14₁-14₃ respectively about the corresponding upper (radially inner most) branches Bᵤ. It is preferred that the core 10′″ is configured so that the volume of core in the upper and lower branch portions Bₗ, Bᵤ of each window 14ᵢ is the same. This assists in avoiding saturation of the core. This can be achieved by appropriate placement or configuration of the windows 14ᵢ. The core 10′″ is depicted as a disc having a relatively small axial length in comparison to its radius. However it may of course be formed with an axial length exceeding the length of its radius.

FIG. 5 illustrates an application of the core 10 shown in FIG. 1. The core 10 is used in this application in a transverse flux motor 26. Full operation and constructional details of the transverse flux motor are described in the Applicant's Australian Application No PP 7124 the contents of which is incorporated herein by way of reference. The structure of core 10 and the placement of primary windings 18₁-18₆ is identical to that described in the first embodiment described in relation to FIG. 1. However, instead of multi turn electrically separate secondary windings a single turn secondary winding between 20ᵢ is provided about each common core portion 16_{i,j} with each of the single turn secondary windings 20ᵢ being in mutual electrical connection. Thus, the single turn secondary windings 20₁-20₆ form a wheel like structure 30 having an inner rim 32 and outer rim 34 joined by radially extending spokes 36. The outer rim 34 is depicted as residing in the air gap 38 of a cockcroft ring 40. Without going into the detail of operation of the motor 26, currents are induced through the single turn secondary windings 20₁-20₆ that interact with magnetic flux passing through the air gap 38 of the cockcroft ring 40 thereby generating transverse forces on the outer rim 34 of the wheel 30 causing it to move. The path of motion of the wheel 30 can be controlled at will by variation of the magnitude and frequency of the primary voltages supplied to the primary coil 18₁-18₆ and the phase relationship therebetween.

Now that embodiments of the present invention have been described in detail it will be apparent to those skilled in the relevant arts and numerous modifications and variations may be made without departing from the basic inventive concepts. For example, in each of the embodiments shown, the core 10 is depicted essentially as being in a ring, annulus or circular type form. However it can assume other shapes provided that it is continuous or endless and is provided with equal numbers of windows and common core portions. Also, the exact number of windows provided is simply dependent upon the application and in particular the number of primary phases. Also, the position and placement of the secondary windings 20ᵢ is dictated solely by the desired magnitude and phase of the secondary outputs.

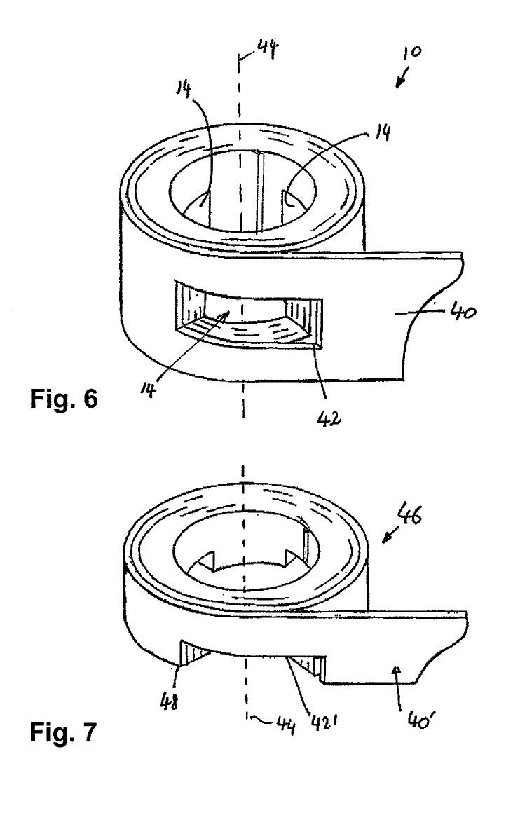

The core 10, 10′, 10″, 10′″ can be made by casting; continuous stamping and winding of an strip of magnetically permeable material; winding of a strip of material then machining/cutting the windows. Naturally, the strip is wound so that its width extends in the direction of the axis of the core. The manufacture of the core by winding of a strip of material is depicted in FIGS. 6-9. With particular reference to FIG. 6, a strip of magnetically permeable material 40, stamped with rectangular cutouts 42 is wound about an axis 44 to produce a core 10. The cutouts 42 are disposed within the periphery of the strip 40 and align circumferentially to produce windows 14.

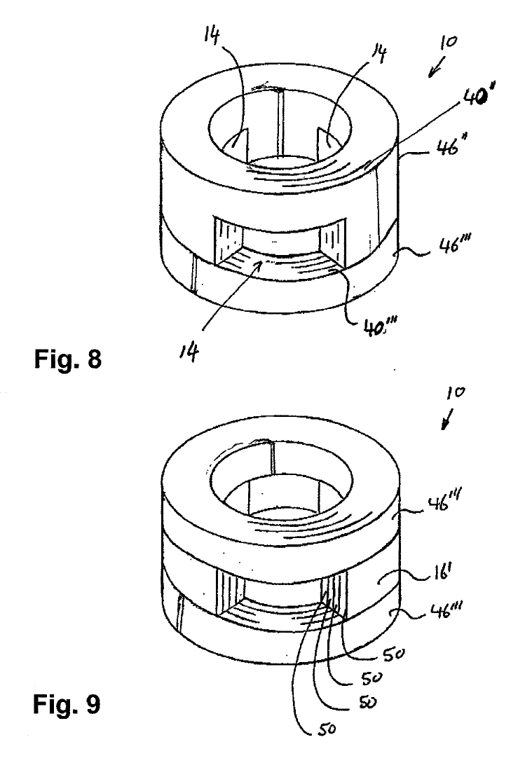

Further the core can be split through a plane passing through the windows 14 to facilitate mechanical/automatic winding of the primary and/or secondary windings about the window branches Bᵤ, B₁, or loading of prewound bobbins on the common core portions 16_{i,j}. The splitting can be effected after winding of the strip, or alternately the core can be initially formed as a split core, i.e. from two separate strips which are wound to form respective rings or loops which can be aligned along a common axis to form the core. This is depicted in FIGS. 7 and 8. In FIG. 8, one (of two) rings or loops 46 is shown being formed by winding of a strip 40′ about an axis 44. The strip 40′ is provided with cutouts 42′ which open onto one edge 48 of the strip 40′. By axially aligning two rings or loops 46 with respective edges 48 and cutouts 46′ facing each other, a core is produced. The facing cutouts 46′ form windows 14 and the formed core is effectively split in a plane passing centrally through the windows 14.

The stamping is for the purpose of producing the windows. If desired when producing the core from separate axially aligned rings or loops, the stamping could be performed on the strips used to form one of the rings or loops only with the full length of the legs provided on that one ring or loop. Thus the one ring or loop provides one branch and two legs of each window 14. Then a second non-stamp ring or loop can be axially aligned and abutted with the previous ring or loop to provide a second branch for each window. This arrangement is depicted in FIG. 8 where two loops 46″ and 46′″ are wound from respective strips 40″ and 40′″. The strip 40″ is provided with cutouts 42″ which open onto edge 48 and include the full length of the legs 16 of the windows 14 of the final assembled core 10. The strip 40′″ forming the ring 46′″ has no cutouts as is simply axially aligned with and abutted against edge 48 of ring 46″ to form the core 10.

The strip can of course be wound for more than 360° as shown most clearly in FIG. 6. In this event it would be preferable to form the windows 14 after winding of the strip by appropriate machining techniques such as laser, wire or water cutting, spark erosion, grinding or milling. Stamping could still be used although the stamping would need to be incremental or indexed to take into account the change in diameter to ensure correct circumferential alignment of the voids left by the stamping to create the windows. When wound for more than 360° it is preferable for the strip to be insulated to reduce the effects of eddy currents in adjacent windings of the strip. This can be achieved with known techniques such as applying a layer of varnish to the strip.

In a further method of construction separate rings or loops can be formed by continuous winding of strips of magnetically permeable material with the rings or loops forming the branches only of the windows and forming the legs separately which are disposed between axially aligned rings or loops. The legs can be formed from the same material as the rings or loops as separate stacked short lengths which are bound or otherwise held together. Thus the axial ends of the separate lengths abut individual turns of the strips forming the rings or loops. In this way a closed magnetic circuit is maintained about each window and each turn or layer constituting each window. This arrangement is shown in FIG. 9 where the core 10 is formed by two rings 46′″ separated by separate intervening legs 16′. Each ring is formed by winding a plain strip of material having no cutouts. The legs 16′ are formed from individual curved plates 50 of material of the same thickness of the strips used for winding the rings 46′″. The number of plates 50 used to form each leg is equal to the number of turns of the strip in each ring 46′″.

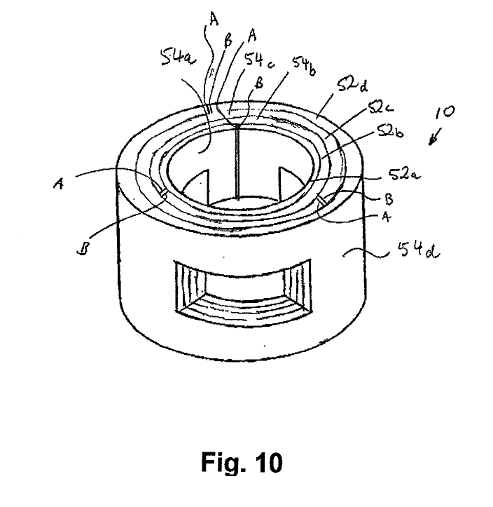

In yet a further variation in the method of manufacture, instead of winding a single strip as described in relation to FIGS. 6-9 a plurality of individual strips could be wound into individual rings with adjacent/abutting ends and axially stacked one inside the other to produce a core. This is depicted in FIG. 10 which illustrates a core 10 made form four strips 52a-52d of material each of which is wound for approximately 360° only about an axis to form corresponding rings 54a-54d. The successively outer rings have greater diameter. Each strip 52a-52d is prior stamped to produce rectangular cutouts 42 which radially align to form windows 14. Due to the change in diameter of successive rings 54 the spacing of the cutouts needs to be indexed or incremented from ring to ring. Clamps 56 may be applied about the core 10 to hold the rings 54 together and ensure that the opposite ends A and B of each ring are closely adjacent each other or abutting. Preferably the ends A and B of the ring are staggered or offset about the core. All of the manufacturing methods described in relation to FIGS. 6-9 can be replicated with individual rings of the type described above in relation to FIG. 10, e.g. the rings 46, 46′, 46″ and 46′″ of FIGS. 6-9 can be formed of concentric separate rings stacked inside each other with closely adjacent/abutting ends A, B.

All such variations and modifications together with others that would be obvious to a person of ordinary skill in the art are deemed to be within the scope of the present invention the nature of which is to be determined from the aforegoing description.

1. A core for a multi-phase transformer, said core including a body made of two or more rings having a common central axis, each ring consisting of a strip of magnetic permeable material wound about said central axis, said body provided with a plurality of windows passing radially through said body, each window bound by opposed axially extending legs and opposed circumferentially extending branches, wherein said branches of each window are provided in respective axially adjacent rings, said branches and legs of each window defining a closed magnetic circuit of substantially uniform magnetic permeability through which magnetic flux can circulate about said windows.

2. The core according to claim 1 including a plurality of primary windings, one primary winding provided for each electrical phase, each primary winding having at least one turn wound directly about a branch or a leg of a corresponding window.

3. The core according to claim 2 wherein at least one of said primary windings is wholly wound about one or both branches of said corresponding window.

4. The core according to claim 2 wherein at least one of said primary windings is wholly wound about one or both legs of said corresponding window.

5. The core according to claim 2 wherein at least one of said primary windings has a plurality of turns wherein at least one of said turns is wound about one branch of said corresponding window and at least one turn is wound about one leg of said corresponding window.

6. A multi-phase transformer including at least:
a core according to claim 1;
a plurality of primary windings, one primary winding being provided for each electrical phase of said transformer; and,
a plurality of secondary windings;
each primary winding having at least one turn wound directly about a branch or a leg of a corresponding window to produce lines of magnetic flux which circulate about said corresponding window; and,
at least one of said secondary windings having at least one turn wound directly about a branch or a leg of a window about which said lines of magnetic flux circulate to induce the current in said at least one secondary winding.

7. The transformer according to claim 6 wherein at least one primary winding is wound directly about at one or both branches of one window, and at least one secondary winding is wound directly about one or both branches of said one window.

8. The transformer according to claim 6 wherein at least one primary winding is wound directly about one or both branches of one window, and at least one secondary winding is wound directly about one or both legs of said one window.

9. The transformer according to claim 6 wherein at least one primary winding is wound directly about one or both branches of one window, and at least one secondary winding is wound directly about at least one branch and at least one leg of said one window.

10. The transformer according to claim 6 where in at least one primary winding is wound directly about one or both branches of one window, and at least one secondary winding is wound directly about a branch or a leg of said one window, and directly about a branch or a leg of another window.

11. The transformer according to claim 6 wherein at least one primary winding is wound directly about one or both legs of one window, and at least one secondary winding is wound directly about one or both branches of said one window.

12. The transformer according to claim 6 wherein at least one primary winding is wound directly about one or both legs of one window, and at least one secondary winding is wound directly about one or both legs of said one window.

13. The transformer according to claim 6 wherein at least one primary winding is wound directly about one or both legs of one window, and at least one secondary winding is wound directly about at least one branch and at least one leg of said one window.

14. The transformer according to claim 6 wherein at least one primary winding is wound directly about one or both legs of a window, and at least one secondary winding is wound directly about at least one branch or one leg of said one window, and about at least one branch or one leg of another window.

15. The transformer according to claim 6 wherein at least one primary winding is wound directly about at least one branch and at least one leg of one window, and at least one secondary winding is wound directly about a branch or a leg of said one window.

16. The transformer according to claim 6 wherein at least one primary winding is wound directly about at least one branch and at least one leg of one window, and at least one secondary winding is wound directly about at least one branch and at least one leg of said one window.

17. A core for a multi-phase transformer, said core including a body made of magnetically permeable material in the shape and configuration of a loop about a central axis, said body provided with a plurality of windows passing axially through said body, each window defined by radially opposite branches and circumferentially opposite legs, where each leg is common to two circumferentially adjacent windows.

18. A core for a multi-phase transformer according to claim 17, including a plurality of primary windings, one primary winding provided for each electrical phase, each primary winding having at least one turn wound directly about a branch or a leg of a corresponding window.

19. A core for a multi-phase transformer according to claim 18 wherein the radially opposite branches of each window are configured to have the same volume of magnetically permeable material.

20. A method of constructing a core according to claim 1, said method including the steps of stamping and winding about said central axis a strip of magnetically permeable material to form said body, said stamping arranged to produce said plurality of windows passing radially through said body.

21. The method according to claim 20 including the step of splitting said core through a plane passing through said windows.

22. A method of constructing a core according to claim 1, said method including the steps of stamping strips of magnetically permeable material to form respective rings, aligning said rings along said common central axis, said stamping and aligning arranged to produce said plurality of windows.

23. A method of constructing a core according to claim 1, said method including the steps of continuous winding about said central axis a strip of magnetically permeable material to form said body; and machining, cutting or otherwise forming said plurality of windows radially through said body.

24. The method according to claim 23 including the step of splitting said core through a plane passing through said windows.

25. The method according to claim 21 including the step of loading a prewound bobbin on one or more legs of said core.

26. The method according to claim 22 including the step of loading a prewound bobbin on one or more legs of said core.

27. The method according to claim 24 including the step of loading a prewound bobbin on one or more legs of said core.

28. A method of constructing a core according to claim 1, said method including the steps of continuous winding strips of magnetically permeable material to form respective rings, and machining or forming said plurality of windows radially through respective rings of said body, aligning said rings along said common central axis to form said body, said machining and aligning arranged to produce said plurality of windows.

29. A method of constructing a core according to claim 1, said method including the steps of continuous winding strips of magnetically permeable material to form respective rings, aligning said rings along said common central axis to form said body, said rings being spaced apart by an array of legs to form a plurality of windows passing radially through said body, wherein said branches of each window are provided in respective axially adjacent rings.
